(19) United States
(12) Patent Application Publication
(10) Pub. No.: US 2014/0027659 A1
(43) Pub. Date: Jan. 30, 2014

(54) VALVE EXTENSION HANDLE

(71) Applicant: Mukesh Kumar, Columbia, SC (US)

(72) Inventor: Mukesh Kumar, Columbia, SC (US)

(21) Appl. No.: 13/558,629

(22) Filed: Jul. 26, 2012

(51) Int. Cl. F16K 31/44

(52) U.S. Cl. 251/213

(57) ABSTRACT

A valve extension handle is disclosed in the present invention. Said valve extension handle is comprised of a extension member with opposed first and second ends, a clamping member connected to the first end of the extension member, and a control member connected to the second end of the extension member. Said clamping member can be attached to the gas tank valve. When the control member connected to the second end of the extension member is turned, the clamping member attached to gas tank valve moves gas tank valve to turn on or shut off the gas flow from said tank.

### BACKGROUND OF THE INVENTION

1. Field of the Invention

The present invention relates to a device for controlling the flow of gases and/or liquids. More particularly, the present invention relates to a valve extension handle for use with control valves or levers of gas tanks or cylinders.

Gas grills employing a liquid propane gas tank fuel supply are wildly used. The common configuration of gas grills is to place the propane gas tank in the cabinet underneath the burners. Propane gas flows to the burner through a tube connected the gas tank and burners. Above the cabinet, there are handles that control the amount of gas flowing into the burners. But the valve that turns on and shuts off the flow of gas into the connection tube and burners are located on the top of the gas tank itself. When the user needs to turn on or shut off the gas flow, he or she usually needs to bends down and contorts himself or herself to access such a valve. And many often, access to the on/off valve of gas tank is difficult because of lack of space.

Therefore, there exists a need for a device, which is used in conjunction with gas tank valve to turn on or shut off such a valve, is easily accessible, and is easily placed at accessible positions.

Accordingly, it is an object of the present invention to provide a control device for use in conjunction with gas tank valve to control the on/off of said valve in an easily accessible and easily operative way.

It is another object of the present invention to provide a control device for use in conjunction with gas tank valve that may be easily made and is durable.

These and other objectives are achieved by the present invention which provides an extension valve handle attached to gas tank valve. There are some prior arts that have used the similar concept of extension to achieve different goals.

For example, U.S. Pat. No. 5,853,060 to Chao et al. discloses a hood latch release system A cable is connected at one end to the hood latch release lever and at the other end to the release handle located inside the vehicle near the driver.

Another example is U.S. Pat. No. 5,379,486 to Wang discloses a pull handle of a trunk, wherein a rod was used to connect the trunk release latch and trunk release handle. But none of these patents addresses the problems that present invention is resolving.

### SUMMARY OF THE INVENTION

In an exemplary embodiment of the present invention, there is disclosed a device for controlling the flow of gases and/or liquids. More particularly, the present invention discloses a valve extension handle for use with control valves or levers of gas tanks or cylinders.

In the preferred embodiment of the present invention, the valve extension handle is comprised of a extension member with opposed first and second ends, a clamping member connected to the first end of the extension member, and a control member connected to the second end of the extension member. Said clamping member attaches the gas tank valve. When the control member connected to the second end of the extension member is turned, the clamping member attached to gas tank valve moves gas tank valve to turn on or shut off the gas flow from said tank.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is an illustration of a conventional grill.

FIG. 2. is an illustration of a conventional grill showing propane tank location inside the grill.

FIG. 3. is an illustration of a propane tank showing the on off valve

FIG. 4 is an illustration of a propane tank on/off valve.

FIG. 5 is an illustration of a conventional grill using the current invention to reposition the propane on/off valve.

FIG. 6 is a illustration of present invention with an extension valve handle attached to a gas tank valve of a conventional grill.

FIG. 7 is a top view of the extension valve handle connected to a gas tank valve wherein the control member is a knob.

FIG. 8 shows the connection of the extension valve handle to gas tank handle.

FIG. 9 is a top view of the extension valve handle connected to a gas tank valve wherein the control member is a lever.

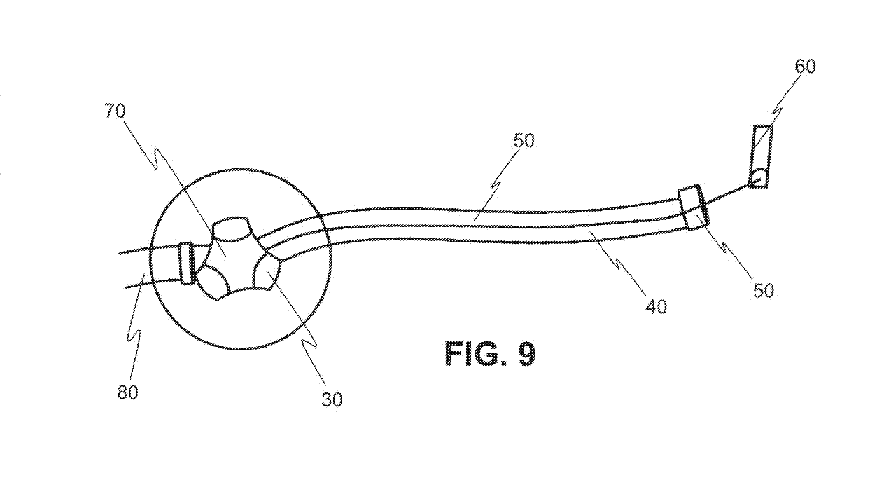

### DESCRIPTION OF THE PREFERRED EMBODIMENT

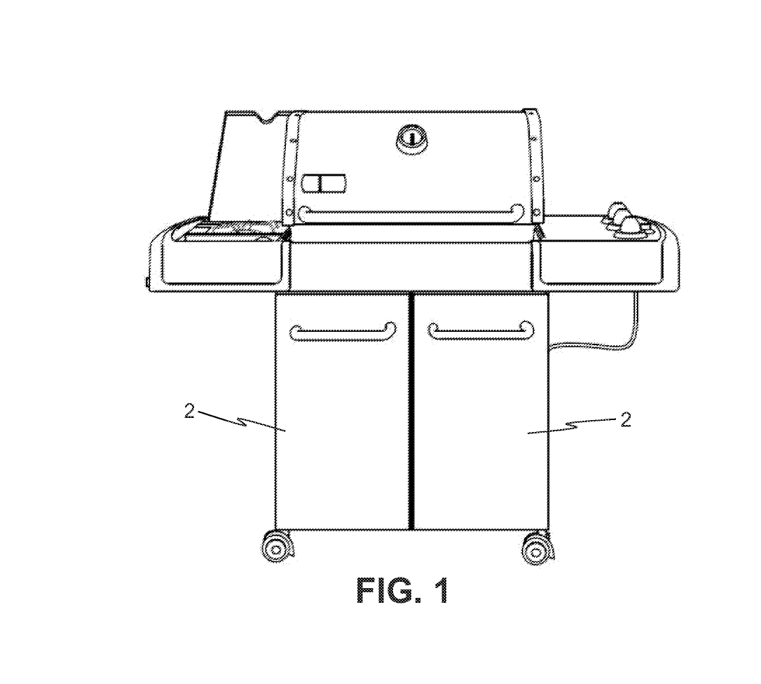

Referring to FIG. 1, there is disclosed a traditional gas grill structure. To set the gas valve to the on or off position the grill user will need to open doors 2 and bend down to turn the gas valve either to an on or off position on the propane tank itself.

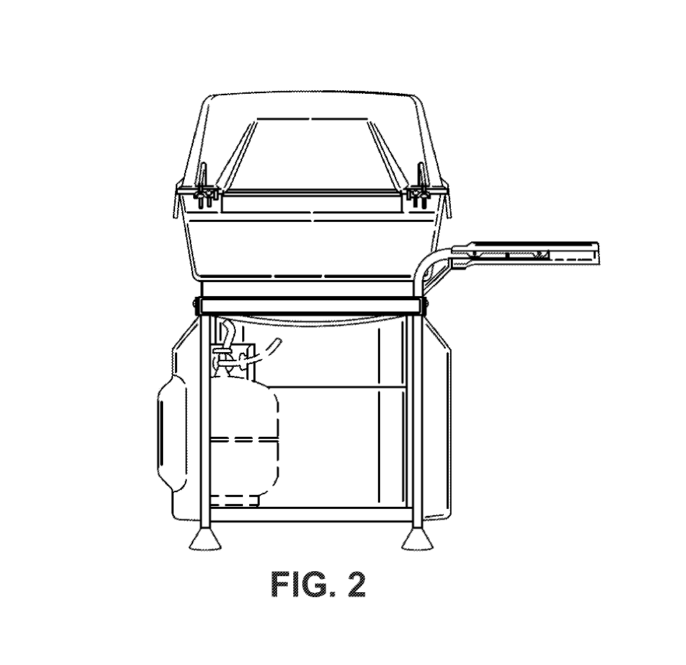

Referring to FIG. 2 there is disclosed a side cut out view of a traditional gas grill structure wherein the propane tank and on off valve can be seen buried deep within the gas grill structure itself.

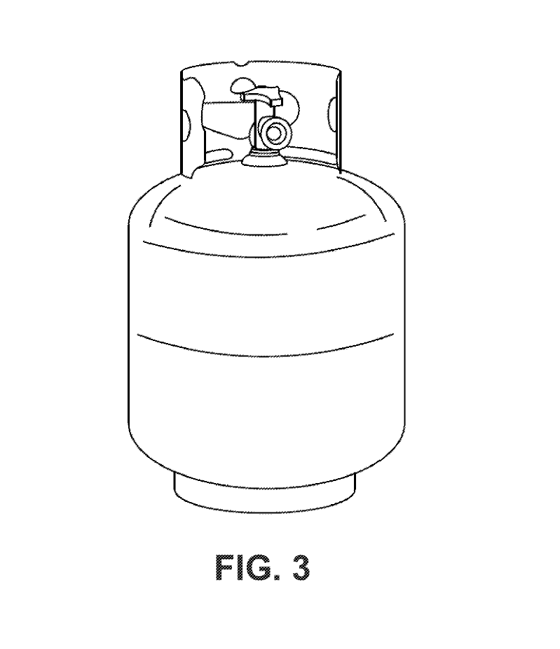

Referring to FIG. 3 there is disclosed a traditional propane tank structure with the on off valve on the top of the structure.

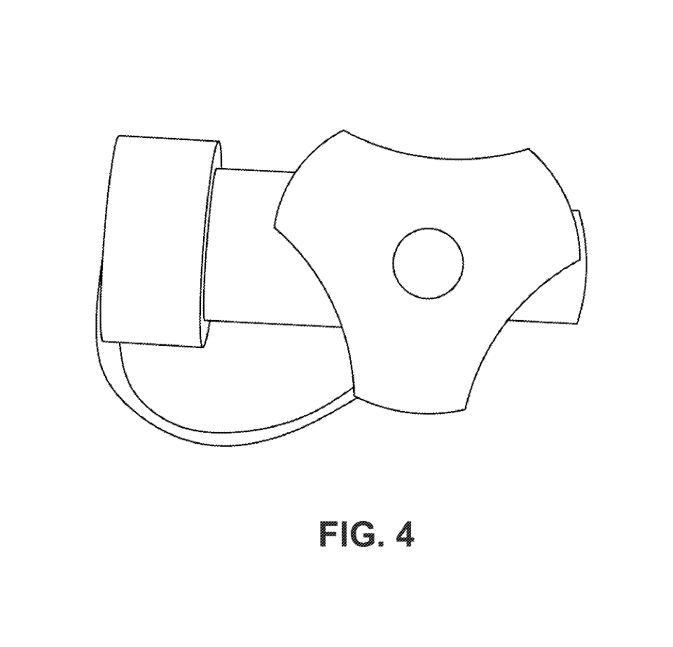

Referring to FIG. 4 there is disclosed a close up view of a traditional propane tank structure showing a close up view of a traditional on/off valve.

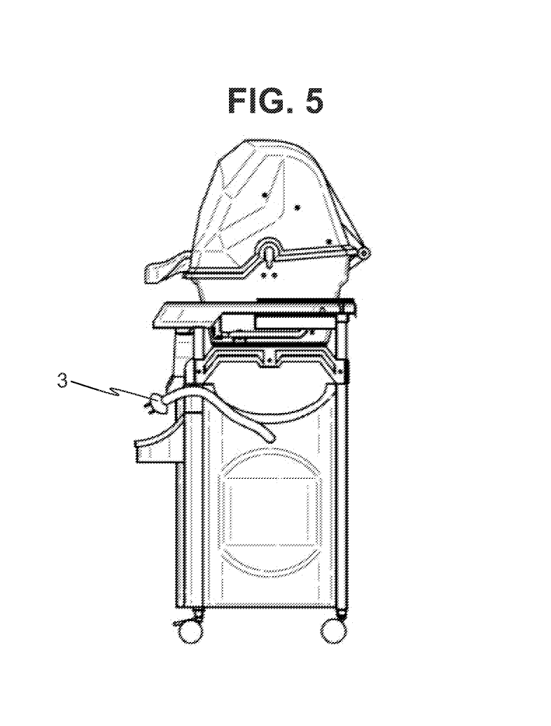

Referring to FIG. 5 there is disclosed a side view cut out of a traditional grill with valve extension handle 3 shown attached to a propane tank and extending the on/off valve of said propane tank to an outside location on the grill.

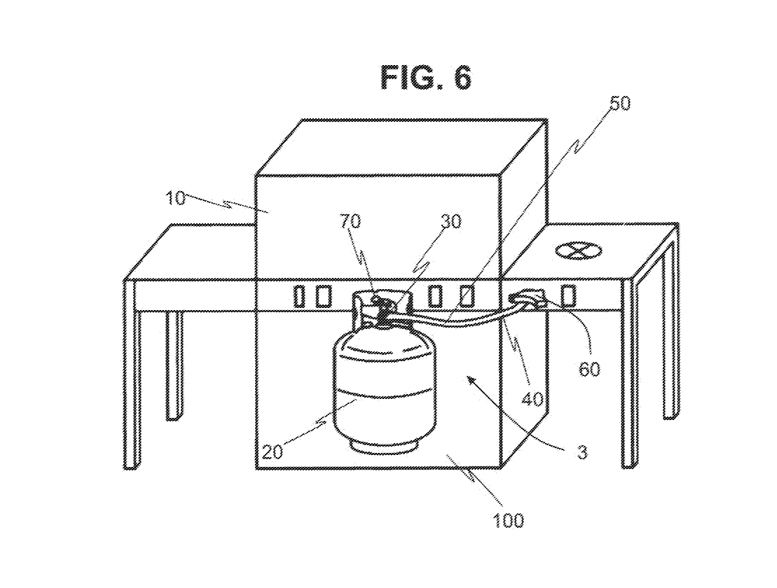

Referring to FIG. 6, there is disclosed a device for controlling the flow of gases and/or liquids. More particularly, the present invention discloses a valve extension handle 3 for use with control valves or levers of gas tanks or cylinders.

As illustrated in FIG. 6, a conventional grill 10 usually has a gas tank 20 placed in a cabinet 100 underneath the burner. Users of the grill needs to bend down to turn on or shut off the gas tank valve 70. With the present invention, a extension valve handle is attached to the gas tank valve 70. The extension valve handle is comprised of an extension member 50 with opposed first and second ends, a clamping member 30 connected to the first end of the extension member 50, and a control member 60 connected second end of the extension member. The extension member 50 is placed inside a flexible hose 40. Said clamping member 30 attaches to the gas tank valve 70. When the control member 60 connected to the second end of the extension member 50 is turned, the clamping member 30 attached to gas tank valve 70 moves, and thus turns on or shuts off the gas flow from said tank 70. The control member 60 may be attached any side or place of the grill.

As shown in FIG. 6, said clamping member 30 securely grasps the gas tank valve 70 and said extension member 50 extends substantially transversely relative to the gas tank 20 towards the outside location of the cabinet 100 so that said control member 60 can be easily placed at a position that is horizontally distant from the gas tank so that the valve extension handle 3 can be easily accessed and control the turning on and shutting off the gas tank valve 70 in an easy way.

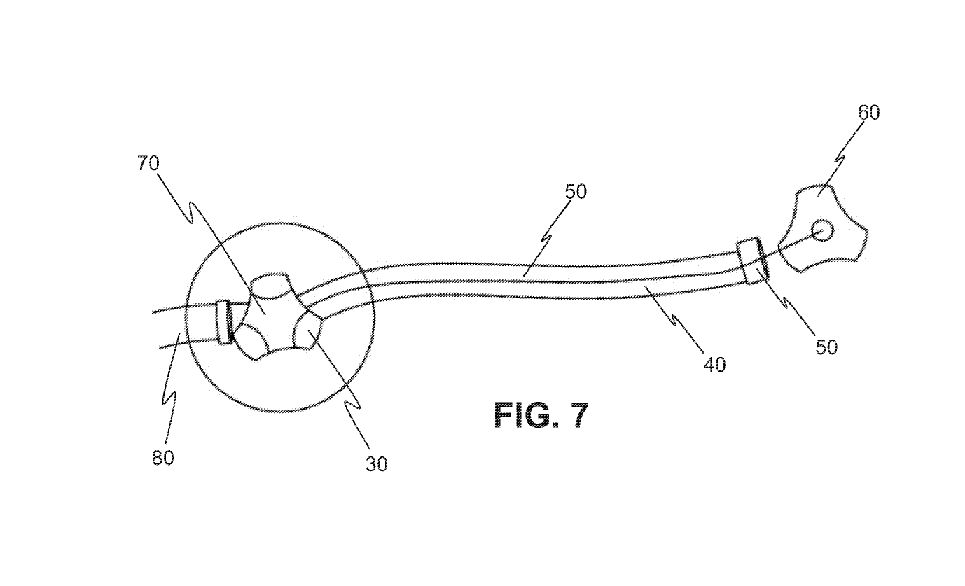

As illustrated in FIG. 7, the extension member 50 may be a flexible wire or a rod. Said extension member 50 is placed inside a flexible hose 40, which may be made of materials, including but not limited to metal, rubber or plastic materials. The extension member 50 is attached to a control member 60, which can be conveniently attached of the grill for easy access. When the user needs to turn on or shut off the gas tank of the grill, he or she only needs to turn the control member 60. At the other end of the extension member 50, a clamping member 30 is connected to the extension member 50. When the control member 60 is turned, the clamping member 30 moves and turns. Then the clamping member 30 drives the gas tank valve 70 to move, either turns on or shut off the gas flow into gas tube 80 connected to burns of the grill.

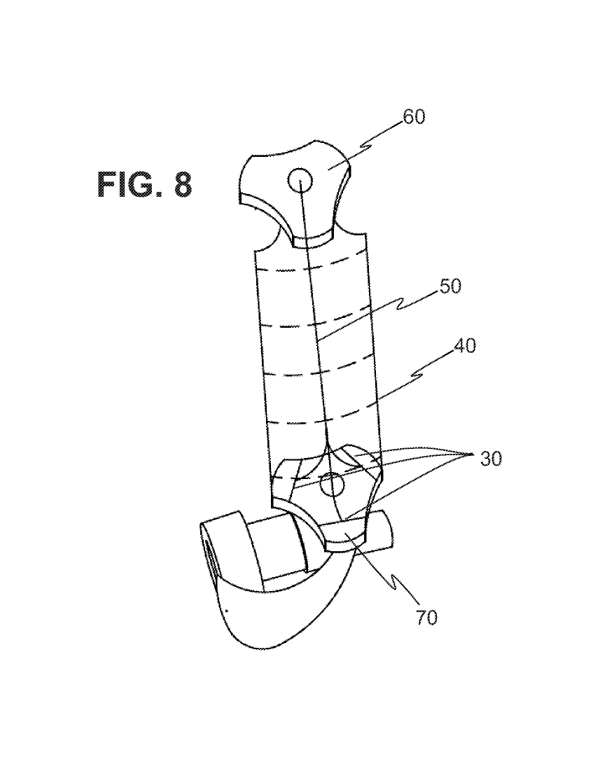

FIG. 8 shows the attachment of the valve extension handle to the gas tank valve.

In the preferred embodiment of the present invention, a valve extension handle is comprised of a extension member with opposed first and second ends, a clamping member connected to the first end of the extension member, and a control member connected to the second end of the extension member. Said clamping member attaches the gas tank valve. When the control member connected to the second end of the extension member is turned, the clamping member attached to gas tank valve moves the gas tank valve to turn on or shut off the gas flow from said tank.

In another embodiment of the present invention, said extension member is a wire or a rod.

In another embodiment of the present invention, said extension member is placed inside a flexible hose.

In another embodiment of the present invention, said flexible hose is made of materials including, but not limited to metal, rubber and plastics.

In another embodiment of the present invention, said control member is a knob or lever.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

1. A valve extension handle for turning on and shutting off a gas tank valve of a grill from a location distant from the gas tank in an easily accessible way, the valve extension handle comprising:
a. an extension member with a first and second ends;
b. a clamping member configured (adapted) to engage the gas tank valve and connected to the first end of said extension member; and
c. a control member connected to the second end of said extension member for controlling turning on and shutting off the gas tank valve via said extension and clamping members;
[W]wherein said clamping member securely grasps the gas tank valve and said extension member extends substantially transversely relative to the gas tank towards the grill such that said control member can be easily placed at a position that is transversely distant from the gas tank for easy access;
wherein said clamping member moves and then turns on or shuts off the gas tank valve when said control member is turned.

2. The valve extension handle of claim 1, further comprising a flexible hose, wherein said extension member is placed inside said flexible hose.

3. The valve extension handle of claim 2, wherein said extension member is a wire or a rod.

4. The valve extension handle of claim 2, wherein said flexible hose is made of materials selected from the group consisting of including, but not limited to metal, rubber and plastics.

5. The valve extension handle of claim 4, wherein said control member is a knob or lever.

6. The valve extension handle of claim 1, wherein said control member is detachably attached to a side of the grill.
